(19) United States
(12) Patent Application Publication
(10) Pub. No.: US 2009/0013820 A1
(43) Pub. Date: Jan. 15, 2009

(54) STEERING SYSTEM

(75) Inventors: David J. Merten, Manitowoc, WI (US); Jay Z. Muchin, Manitowoc, WI (US)

Correspondence Address: RATHE PATENT & IP LAW, 10611 W. HAWTHORNE FARMS LANE, MEQUON, WI, 53097, US

(73) Assignee: M Group, Inc., Manitowoc, WI (US)

(21) Appl. No.: 12/170,419

(22) Filed: Jul. 9, 2008

Related U.S. Application Data
(60) Provisional application No. 60/948,682, filed on Jul. 9, 2007.

(51) Int. Cl. G05G 1/10

(52) U.S. Cl. 74/558

(57) ABSTRACT

A steering system has a steering wheel with an opening configured to mount a steering knob. In one embodiment, the system includes a cover removably coupled to the steering wheel to at least partially cover the opening. In one embodiment, the steering knob has three protuberances equally spaced about the knob.

### CROSS-REFERENCE TO RELATED PATENT APPLICATIONS

The present application claims priority under 35 USC 119(e) from co-pending U.S. Provisional Application Ser. No. 60/948,682 filed on Jul. 9, 2007 by David J. Merten and Jay Z. Muchin and entitled STEERING SYSTEM, with full disclosure of which is hereby incorporated by reference.

### BACKGROUND

Steering wheels are sometimes used to steer a vehicle. Some steering wheels include a steering knob to facilitate one-handed steering. Current methods of providing a steering wheel with a steering knob may be difficult, may damage the steering wheel and may not accommodate different user ergonomics or preferences.

### BRIEF DESCRIPTION OF THE DRAWINGS

FIG. 1 is a top perspective view of a steering system according to an example embodiment.

FIG. 2 is an enlarged fragmentary top perspective view of a cover in a steering wheel of the steering system of FIG. 1.

FIG. 3 is an enlarged fragmentary top perspective view of the cover of FIG. 2 removed from the steering wheel.

FIG. 4 is an enlarged fragmentary top perspective view of the system of FIG. 1 illustrating a steering knob removed from the steering wheel.

FIG. 5 is an enlarged fragmentary top perspective view of the system of Figure numeral for illustrating the steering knob inserted into the steering wheel.

FIG. 6 is a top perspective view of another embodiment of the steering system of FIG. 1.

### DETAILED DESCRIPTION OF THE EXAMPLE EMBODIMENTS

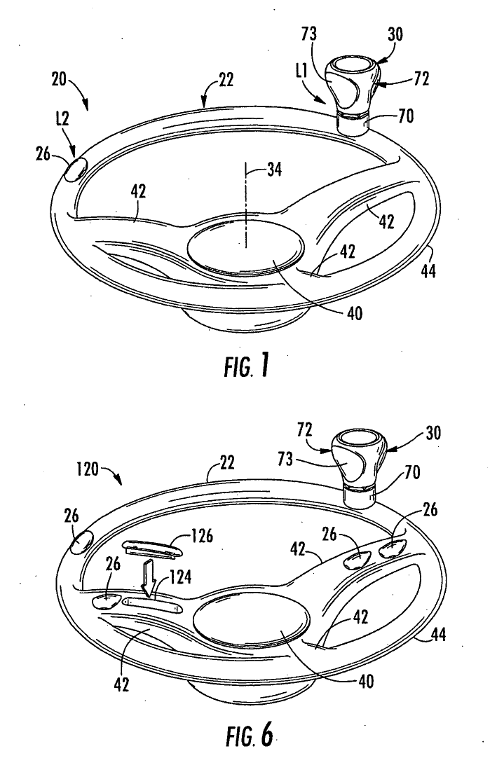

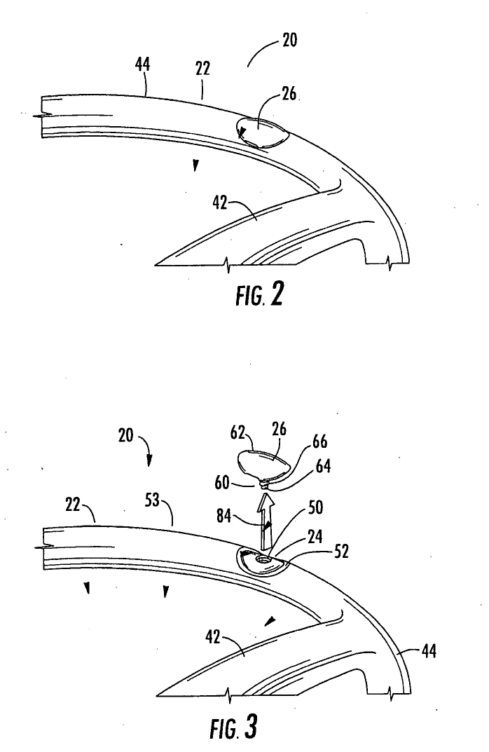

FIG. 1 is a top perspective view illustrating a steering system 20 according to an example embodiment. The steering system 20 includes steering wheel 22, openings 24 (one of which is shown in FIG. 3), cover 26 and knob 30. Steering wheel 22 comprises a structure configured to steer a mechanism, a machine or a vehicle, such as a land vehicle, a water vehicle or an air vehicle. Examples of land vehicle include, but are not limited to, a truck, a car, a lawnmower, an all-terrain vehicle and the like. Examples of water vehicles and air vehicles include, but are not limited to, boats and planes, respectively.

Steering wheel 22 is configured to be manually rotated (potentially with a power assist, such as hydraulics, pneumatics and the like) about axis 34 and generally includes a hub 40, spokes 42 and rim 44. Hub 40 comprises a central portion supporting a remainder of wheel 22 and connecting the remainder of wheel 22 to a steering shaft or steering column (not shown). Spokes 42 project outwardly from hub 40 and are connected to rim 44. Rim 44 comprises a ring encircling axis 34 and configured to be grasped by person to manually steer a vehicle. In the example illustrated, rim 44 is generally circular. In other embodiments, rim 44 may be ovular or may have other shapes about axis 34.

Openings 24, one of which is shown in FIG. 3, comprise bores, cavities, recesses, depressions, channels or other surface or shape irregularties extending at least partially into steering wheel 22 and configured cooperate with knob 30 to retain knob 30 in place. Openings 24 are further configured to receive at least portions of a cover 26 to facilitate releasable securement of cover 26 to steering wheel 22. As shown in FIG. 3, in one embodiment, opening 24 includes a main bore 50 and a countersink recess 52. Main bore 50 extends into steering wheel 22 and is configured to receive a projection of knob 30. In one embodiment, main bore 50 only partially extends through steering wheel 22 such that main bore 50 extends from an upper surface 53 of steering wheel 22 and terminates at an internal floor. In other words, bore 50 is a blind hole. As a result, a lower surface of steering wheel 22 does not have an opening there through, strengthening steering wheel 22 and providing a smoother uninterrupted surface along a bottom side of steering wheel 22. In other embodiments, bore 50 may extend completely through steering wheel 22.

Countersink recess 52 comprises a shallower recess or cavity about border 50. Countersink recess 52 facilitates a more flush reception of cover 26. In other embodiments, countersink recess 52 may be omitted.

Cover 26 comprises a structure configured to extend at least partially across opening 24 so as to at least partially cover opening 24 when opening 24 is not being occupied by knob 30. Cover 26 is further configured to provide a smoother, less interrupted surface along steering wheel 22, facilitating enhanced gripping of those portions of steering wheel 22 that happen to include a cover 26.

In the example illustrated, cover 26 comprises a plug which is at least partially received within the bore serving as opening 24. As shown by FIG. 3, cover 26 includes connection portion 60 and cover portion 62. Connection portion 60 facilitates connection of cover 26 to steering wheel 22. In one embodiment, connection portion 60 includes a shaft 64 having outwardly extending projecting projections 66. Projections 66 extend outwardly from shaft 60 by a distance so as to engage interior surfaces of bore 50. In one embodiment, projections 66 are resiliently flexible so as to deform, compress or flex into engagement with interior surfaces or structures of bore 50 to frictionally retain cover 26 within bore 50 and to attach knob 30 to steering wheel 22. In another embodiment, projections 66 may be rigid and inflexible, where surfaces or portions within bore 50 are resiliently flexible. In one embodiment, projections 66 may comprise one or more annular rings. In yet other embodiments, projections 64 may comprise teeth to secure cover 26 to steering wheel 22. As noted above, depending upon the configuration of surfaces or structures within bore 50, projections 66 may be resiliently flexible or inflexible.

In one embodiment, bore 50 may include corresponding resiliently flexible rings or teeth. In yet other embodiments, connection portion 60 may include resiliently flexible prongs or tabs, wherein the prongs or tabs resiliently flex inwardly during insertion into bore 50 and resiliently flex outwardly to engage corresponding teeth or grooves within bore 50. In yet other embodiments, connection portion 60 may include external threads configured to be threadably received within corresponding threaded grooves within bore 50.

Cover portion 62 comprises that portion of cover 26 configured to overlie and cover or conceal bore 50. As shown by FIGS. 1 and 2, cover portion 62 at least partially overlies countersink recess 52 and extends substantially flush with surfaces of steering wheel 22 adjacent to or at least proximate to countersink recess 52. Cover 26 has outer perimeter edges which smoothly and gradually taper or ramp down to such surfaces about opening 24. As a result, cover 26 smoothly blends into surrounding surfaces of steering wheel 22, providing a smooth transition and enhanced grip or feel for a person using steering wheel 22. In the particular embodiments illustrated, cover portion 26 has an elongated ovular shape, further enhancing the ability of cover portion 26 to smoothly blend with the remainder of steering wheel 22. In other embodiments, cover portion 22 may have other shapes and may alternatively not smoothly taper or blend with adjacent portions of steering wheel 22.

According to one embodiment, cover 26 has an exterior outermost surface formed from a compressible and soft rubber-like material. In one embodiment, cover 26 is formed from the same material and has the same color and texture as adjacent portions of steering wheel 22 to conceal cover 26 and to provide a user with the same feel when gripping cover 26 or steering wheel 22. In other embodiments, cover portion 62 may be formed from other materials.

As shown by FIG. 4, steering knob 30 comprises one or more structures configured to be mounted to steering wheel 22 so as to project from steering wheel 22 and provide an alternative grip for steering wheel 22. Steering knob 30 includes connection portion 70 and gripping portion 72. Connection portion 70 comprises a base 74 and a projection 76 extending from base 74. Projection 76 is configured to be at least partially received within bore 50 and to secure knob 30 to steering wheel 22. In one embodiment, projection 76 includes a plurality of annular rings configured to engage corresponding teeth or rings within bore 50. In another embodiment, project 76 may include a plurality of radially extending teeth configured to engage corresponding teeth or rings within bore 50. In one embodiment, the teeth or rings of projection 76 are resiliently flexible. In another embodiment, the rings or teeth a projection 76 may be inflexible, wherein the corresponding rings or teeth within bore 50 are resiliently flexible. In yet another embodiment, projection 76 may include external threads and bore 50 may include internal threads, permitting connection portion 70 to be screwed to steering wheel 22. In other embodiments, projection 76 may be configured to be received within bore 50 while securing knob 30 to steering wheel 22 in other fashions.

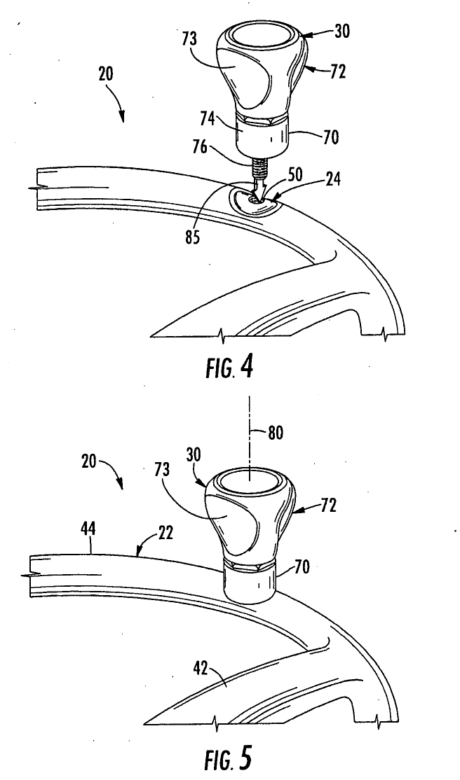

As shown by FIG. 5, gripping portion 72 comprises a bulbous member rotationally coupled to connection portion 70 so as to rotate or spin about axis 80 (shown in FIG. 5). In one embodiment, axis 80 extends substantially parallel to axis 34 (shown in FIG. 1). In another embodiment, knob 30 may be configured to rotate about an axis 80 that is oblique to axis 34. In one embodiment, knob 30 is configured to freely spin 360° about axis 80. As shown in FIG. 1, knob 30 rotates about axis 80 that is substantially perpendicular to a plane containing rim 44. In other embodiments, axis 80 may be slightly angled and oblique with respect to the plane containing rim 44.

As further shown by FIG. 5, gripping portion 72 has three convex surfaces or protuberances 73 equiangularly located about axis 80. In one embodiment, such protuberances 73 are injection molded. In other embodiments, such protuberances may be formed other fashions. Because knob 30 includes three such protuberances 73 having center points and angularly spaced 120 degrees apart from one another, knob 30 80 more comfortably gripped in the palm of a person's hand. In other embodiments, knob 30 may be provided with a greater or fewer number of such protuberances. In other embodiments, knob 30 may alternatively have a smooth outer spherical surface.

FIGS. 2-5 illustrate how steering system 20 permits a person to selectively add steering knob 30 to a desired location on steering wheel 22. As shown by FIG. 2, steering wheel 22 is provided with one or more covers 26 which are removably received within openings 24 (shown in FIG. 3). As shown in FIG. 3, cover 26 is removed from opening 24 and separated from steering wheel 22 as indicated by arrow 84. As shown by FIG. 4, steering knob 30 is then mounted in its place by lowering projection 76 into bore 50 as indicated by arrow 85. Thereafter, steering knob 80 is ready for use. Alternatively, if the person does not desire to include or use steering knob 30, the person may leave cover 26 in place as shown in FIG. 2. Because cover 26 blocks bore 50 and provides a relatively smooth cover and interface over bore 50, a person may use steering wheel 22 in a normal fashion without encountering interference from cover 26.

As shown in FIG. 1, according to one example embodiment, steering wheel 22 may include a plurality of openings 24 and a plurality of corresponding covers 26 received within such openings 24. The openings 24 and corresponding covers 26 may be provided at a multitude of distinct locations on steering wheel 22. In particular, as shown by FIG. 1, such openings 24 and cover 26 may be provided at a plurality of distinct locations along rim 44. As a result, steering system 20 enables a person to select a desired location for steering knob 30. Because steering wheel 22 is generally not freely rotatable about axis 30 for a full 360° or is not rotatable about axis 30 for my greater than 360 degrees, steering system 20 enables a person to locate steering knob 30 at a desired location with respect to a certain extent of angular rotation of steering wheel 22 about axis 34. For example, when knob 30 is mounted at location L1, rotation of steering wheel 22 so as to locate knob 30 that the 12 o'clock position (when viewed from the top of steering wheel 22) may correspond to rotation of steering wheel 22 a first angular extent in a counter-clockwise direction from center (the location in which direction of travel of the machine or vehicle is straight). Alternatively, when knob 30 is mounted at location L2, rotation of steering wheel 22 so as to locate knob 30 at the 12 o'clock position (when viewed from the top of steering wheel 22) may correspond to rotation of steering wheel 22 a second angular extent in a clockwise direction from center.

FIG. 6 illustrates steering system 120, another embodiment of steering system 20. Steering system 120 is similar to steering system 20 except steering system 120 includes a greater number of openings 24 and covers 26 at additional locations in steering wheel 22. In the example shown, steering system 120 includes additional openings 24 (shown in FIG. 3, but covered by covers 26 in FIG. 6) and additional covers 26 (opening 24 and covers 26 been described above) in spokes 42 of steering wheel 22. As shown by FIG. 6, such additional openings 24 and covers 26 are located at radial ends of different spokes 42 proximate to rim 44. As a result, such openings 24 and covers 26 provide a person with additional choices regarding the location of steering knob 30. In particular, the openings 24 and covers 26 located in spokes 42 provide additional circumferential locations about axis 34 at which knob 30 may be mounted. In addition, the openings 24 and covers 26 provide location choices for steering knob 30 which are radially inward of those location options provided by the openings 24 and covers 26 in rim 44. As shown in FIG. 6, multiple openings 24 and covers 26 may be provided along a single one of spokes 42, providing a person with multiple radial positions with respect to axis 34 between hub 40 and rim 44 at which a steering knob 30 may be mounted. Although openings 24 and covers 26 are illustrated at the depicted locations, in other embodiments, openings 24 and covers 26 may be provided at other locations on steering wheel 22.

As further shown by FIG. 6, system 120 additionally includes opening 124 and cover 126. Opening 124 comprises an elongate slot in steering wheel 22. In one embodiment, opening 124 is blind. In another embodiment, opening 124 extends through wheel 124. In one embodiment, an additional fastener, such as a nut, may be screwed onto projection 76 on a lower side of wheel 22 secure knob 30 at a selected location along opening 26. In such an embodiment, opening 26 may have a countersink or enlarge opening portion on the bottom side to receive the fastener such that the fastener does not project beyond wheel 22. Opening 124 permits knob 30 to be selectively positioned at any one of a plurality of positions that continuously extend along the length of opening 124. As a result, opening 124 facilitates more precise positioning of knob 30 at a desired location.

Cover 126 is similar to cover 26 except that cover 126 is elongated so as to fill opening 124. Cover 126 is inserted into opening 124 when knob 30 is mounted in one of openings 26 or is not used. Although opening 124 is illustrated as being in spoke 42, in other embodiments, opening 124 may be in rim 44. In other embodiments, opening 124 and cover 126 may be omitted.

According to one embodiment, steering wheel 22 with openings 24 and covers 26 are provided as a kit for replacing an existing steering wheel. In one embodiment, the kit may additionally include steering knob 30. According to another embodiment, a machine or vehicle may be provided with steering wheel 22, openings 24 and covers 26, providing a person with an option of later acquiring steering knob 30 and mounting steering knob 30 at a desired location. In yet another embodiment, the machine or vehicle may be provided with each of steering wheel 22, openings 24, covers 26 and knob 30, providing a person with the option of using steering knob 30 and mounting steering knob 30 at a desired location or not using or mounting steering knob 30 to wheel 22. Although steering system 20 and steering system 120 are both illustrated as including multiple openings 24 and multiple covers 26 providing a person with multiple location options for steering knob 30, in other embodiments, a single opening 24 and a single cover 26 may be provided. In still other embodiments, an even greater number of openings 24 and covers 26 than those shown may be provided.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a steering wheel having a first opening configured to mount a knob; and
a first cover removably coupled to the steering wheel to at least partially cover the first opening.

2. The apparatus of claim 1, wherein the first cover extends flush with a surface of the wheel proximate the opening.

3. The apparatus of claim 1 further comprising:
a second opening in the wheel; and
a second cover removably coupled to the steering wheel to at least partially cover the second opening.

4. The apparatus of claim 1, wherein the first opening extends through the wheel.

5. The apparatus of claim 1, wherein the first opening extends from a top surface of the wheel and terminates at a floor.

6. The apparatus of claim 1, wherein the wheel includes a hub, a rim and spokes extending between the hub and the rim, wherein the first opening is along the rim.

7. The apparatus of claim 6 further comprising a second opening along the rim.

8. The apparatus of claim 7 further comprising a second cover removably coupled to the steering wheel to at least partially cover the second opening.

9. The apparatus of claim 7 further comprising a third opening in one of the spokes.

10. The apparatus of claim 9 further comprising a third cover removably coupled to the steering wheel to at least partially cover the third opening.

11. The apparatus of claim 9, wherein the third opening is proximate the rim.

12. The apparatus of claim 6 further comprising a second opening in one of the spokes.

13. The apparatus of claim 1, wherein the wheel includes a hub, a rim and spokes extending between the hub and the rim, wherein the first opening is in one of the spokes.

14. The apparatus of claim 1, wherein the cover has a compressible elastomeric surface.

15. The apparatus of claim 1, wherein the cover includes a shaft having at least one resiliently flexible projection configured to engage an interior of the first opening.

16. The apparatus of claim 15, wherein the projection comprises a resiliently flexible ring extending about the shaft.

17. The apparatus of claim 1, wherein the first cover has an ovular shaped top portion.

18. A kit comprising:
a steering wheel having a plurality of openings; and
a plurality of covers configured to be removably coupled to the steering wheel to at least partially cover the openings.

19. The kit of claim 18 further comprising a steering knob configured to be rotationally mounted to the steering wheel in one of the plurality of openings.

20. A steering wheel knob comprising:
a base;
a gripping portion extending from the base, the gripping portion having three convex protuberances equi-angularly spaced about a rotational axis of the knob.

21. An apparatus comprising:
a steering wheel having a non-uniform rim including a surface irregularity configured to cooperate with a steering knob to retain the steering knob on the steering wheel.
